(19) United States
(12) Patent Application Publication
(10) Pub. No.: US 2025/0158211 A1
(43) Pub. Date: May 15, 2025

(54) BATTERY

(71) Applicant: TOYOTA JIDOSHA KABUSHIKI KAISHA, Toyota-shi (JP)

(72) Inventors: Kota OHATA, Toyota-shi (JP); Masahiro ISHIZUKA, Toyota-shi (JP); Hajime HASEGAWA, Aichi-ken (JP); Mitsuru TATEISHI, Toyota-shi (JP); Norihiro OSE, Nagoya-shi (JP); Masashi CHIHARA, Nagoya-shi (JP)

(21) Appl. No.: 18/900,910

(22) Filed: Sep. 30, 2024

(30) Foreign Application Priority Data
Nov. 15, 2023 (JP) 2023-194669

(51) Int. Cl. H01M 50/333; H01M 50/103

(52) U.S. Cl. CPC H01M 50/333; H01M 50/103; H01M 2200/20

(57) ABSTRACT

A battery including: an electrode body and a laminate exterior body accommodating the electrode body at an interior thereof. The laminate exterior body has a mechanism that switches from the closed state to the open state when a pressure of the interior of the laminate exterior body exceeds a threshold value. The laminate exterior body has a rectangular parallelepiped shape, and has first sides extending in a first direction and second sides extending in a second direction orthogonally intersecting the first direction. The mechanism is positioned within a virtual region enclosed by first virtual straight lines including the pair of first sides and by second virtual straight lines including the pair of second sides. A length of the mechanism is shorter than a length of the laminate exterior body in a third direction orthogonally intersecting each of the first direction and the second direction.

### CROSS-REFERENCE TO RELATED APPLICATION

This application is based on and claims priority under 35 USC 119 from Japanese Patent Application No. 2023-194669, filed on Nov. 15, 2023, the entire disclosure of which is incorporated by reference herein.

### BACKGROUND

### Technical Field

The present disclosure relates to a battery.

### Related Art

Japanese Patent Application Laid-open (JP-A) No. 2023-11650 specifically discloses the power storage device 900 (hereinafter, also referred to as “battery 900”) shown in FIG. 6. The battery 900 includes a housing body 910 (hereinafter, also referred to as “laminate exterior body 910”), a power storage device element 920 (hereinafter, also referred to as “electrode body 920”), a pair of tabs 930, a tab film 940, a valve device 950, and a heat fusion film 960.

The laminate exterior body 910 houses the electrode body 920. The laminate exterior body 910 has an internal space R910A and a peripheral seal part R910B. The laminate exterior body 910 has a rectangular shape in plan view. The laminate exterior body 910 has a pair of long sides 911 and a pair of short sides 912 in plan view.

The valve device 950 is attached to the laminate exterior body 910. A specific heat-weldable film 860 is heat-welded between the laminate exterior body 910 and the valve device 950. When the pressure inside the laminate exterior body 910 (hereinafter, also referred to as “internal pressure”) reaches a predetermined pressure owing to the gas generated inside the laminate exterior body 910 (hereinafter, also referred to as “internal gas”), the valve device 950 discharges the internal gas to the outside of the laminate exterior body 910, whereby the internal pressure is reduced.

However, the valve device 950 protrudes from a region enclosed by the pair of long sides 911 and the pair of short sides 912 (hereinafter, also referred to as an “exterior body region”). Therefore, when plural batteries 900 are housed in a case, forming a module, it is necessary to secure a space (also referred to as a “valve device housing space”) for housing the valve device 950 protruding from the exterior body region inside the case. The valve device housing space does not contribute to the battery reaction. As a result, the volumetric efficiency of the module may not be sufficient. The “volumetric efficiency of the module” refers to the ratio of the volume of the electrode body in which the battery reaction is carried out with respect to the total volume of the module.

### SUMMARY

The present disclosure has been made in view of the above circumstances.

The problem to be solved by one embodiment of the present disclosure is to provide a battery in which, when the internal pressure is excessively increased, the internal gas can be released to the outside, and the volumetric efficiency of the module can be improved.

The means for solving the above problem includes the following embodiments.

<1> A battery of a first aspect of the present disclosure includes:
an electrode body; and
a laminate exterior body accommodating the electrode body at an interior thereof, in which:
the laminate exterior body has a mechanism switchable between a closed state of closing the interior and an open state of opening the interior to an exterior of the laminate exterior body,
the mechanism switches from the closed state to the open state when a pressure of the interior of the laminate exterior body exceeds a threshold value,
the laminate exterior body has a rectangular parallelepiped shape,
the laminate exterior body has, in plan view, a pair of first sides extending in a first direction and a pair of second sides extending in a second direction orthogonally intersecting the first direction,
the mechanism is positioned within a virtual region enclosed by a pair of first virtual straight lines including the pair of first sides and by a pair of second virtual straight lines including the pair of second sides, and
a length of the mechanism is shorter than a length of the laminate exterior body in a third direction orthogonally intersecting each of the first direction and the second direction.

A “laminate exterior body” refers to a case made of a laminate sheet. A “laminate sheet” refers to a sheet having a metal layer, a first resin layer layered on one main surface of the metal layer, and a second resin layer layered on the other main surface of the metal layer. A “rectangular parallelepiped shape” refers to a concept including not only a perfect rectangular parallelepiped but also a substantially rectangular parallelepiped (for example, a shape in which at least one side is partially chamfered). A “plan view” refers to viewing from a direction orthogonal to the main surface of the laminate exterior body (i.e., the third direction).

At a time of battery abnormality, there are cases when gas generated in the interior of the laminate exterior body (hereinafter, referred to as “internal gas”) is produced, and the pressure inside the laminate exterior body (hereinafter, also referred to as “internal pressure”) excessively increases. In the first aspect, therefore, the laminate exterior body has a mechanism whereby the battery of the first aspect can release the internal gas to the outside when the internal pressure excessively increases. As a result, the occurrence of rupturing of the laminate exterior body in the battery of the first aspect is suppressed. In other words, the safety of the battery of the first aspect is excellent.

In the first aspect, the mechanism is positioned inside a virtual region in plan view. Furthermore, in the third direction, the length of the mechanism is less than the length of the laminate exterior body. Therefore, when plural batteries of the first aspect are housed in a case, forming a module, it is not necessary to secure the conventional valve device housing space inside the case. As a result, the battery of the first aspect can improve the volumetric efficiency of the module.

<2> A battery of a second aspect of the present disclosure is the battery of the first aspect, in which:
the laminate exterior body is configured by laminate sheets,
the laminate exterior body has:
   a non-welded region at which the laminate sheets are not welded together; and
   a welded region sealing the non-welded region and at which the laminate sheets are welded together,
the non-welded region includes:
   a housing region housing the electrode body; and
   an intermediate region positioned between the housing region and the welded region,
the intermediate region includes:
   at least one through-hole penetrating the laminate sheet; and
   a lid part welded to the laminate sheet and occluding the through-hole,
a thickness of the lid part is less than a thickness of the laminate sheet,
the mechanism includes the lid part occluding the through-hole,
the closed state refers to a state in which the lid part is not torn, and
the open state refers to a state in which the lid part is torn.

In the second aspect, the mechanism includes a lid part which occludes the through-hole. The thickness of the lid part is less than the thickness of the laminate sheet. In other words, the strength of the lid part is relatively low. Therefore, when the internal pressure excessively increases, the lid part is susceptible to tearing. As a result, the battery of the second aspect can release the internal gas to the outside when the internal pressure excessively increases, with a simple configuration.

<3> A battery of a third aspect of the present disclosure is the battery of the first aspect, in which:
the laminate exterior body is configured by laminate sheets,
the laminate exterior body has:
   a non-welded region at which the laminate sheets are not welded together; and
   a welded region sealing the non-welded region and at which the laminate sheets are welded together,
the non-welded region includes a housing region housing the electrode body,
the welded region has:
   a main part having a specific welding width; and
   at least one narrow part having a smaller welding width than the specific welding width,
the closed state refers to a state in which the laminate sheets are welded together at the narrow part, and
the open state refers to a state in which the laminate sheets are separated from each other at the narrow part.

In the third aspect, the mechanism includes at least one narrow part. In other words, the laminate sheets welded at the narrow part are more susceptible to being separated from each other than the laminate sheets welded at the main part. Therefore, when the internal pressure excessively increases, it is easier for the laminate sheets, which are welded at the narrow part, to be separated from each other. As a result, the battery of the third aspect can release the internal gas to the outside when the internal pressure excessively increases, with a simple configuration.

<4> A battery of a fourth aspect of the present disclosure is the battery of the first aspect, in which:
the laminate exterior body is configured by laminate sheets,
the laminate exterior body has:
   a non-welded region at which the laminate sheets are not welded together; and
   a welded region sealing the non-welded region and at which the laminate sheets are welded together,
the non-welded region includes a housing region housing the electrode body,
the mechanism includes at least one check valve,
the check valve includes:
   a body part forming a gas flow path communicating the non-welded part with the exterior of the laminate exterior body; and
   an on-off valve configured to open and close the gas flow path,
the welded region includes a region at which the body part is interposed between the laminate sheets,
the closed state refers to a state in which the gas flow path is closed by the on-off valve, and
the open state refers to a state in which the gas flow path is opened by the on-off valve.

In the fourth aspect, the mechanism includes at least one check valve. The check valve can return from the open state to the closed state. As a result, the battery of the fourth aspect functions as a battery even after the internal pressure has excessively increased.

According to the present disclosure, a battery is provided in which, when the internal pressure rises excessively, the internal gas can be released to the outside, and the volume efficiency of the module can be improved.

### BRIEF DESCRIPTION OF THE DRAWINGS

Exemplary embodiments of the present invention will be described in detail based on the following figures, wherein:

FIG. 1 is a front view of a battery according to a first embodiment of the present disclosure;

FIG. 2 is a cross-sectional view taken along line II-II of FIG. 1;

FIG. 3 is a front view of a battery according to a second embodiment of the present disclosure;

FIG. 4 is a front view of a battery according to a third embodiment of the present disclosure;

FIG. 5 is a cross-sectional view taken along line V-V of FIG. 4; and

FIG. 6 is a front view of a conventional battery.

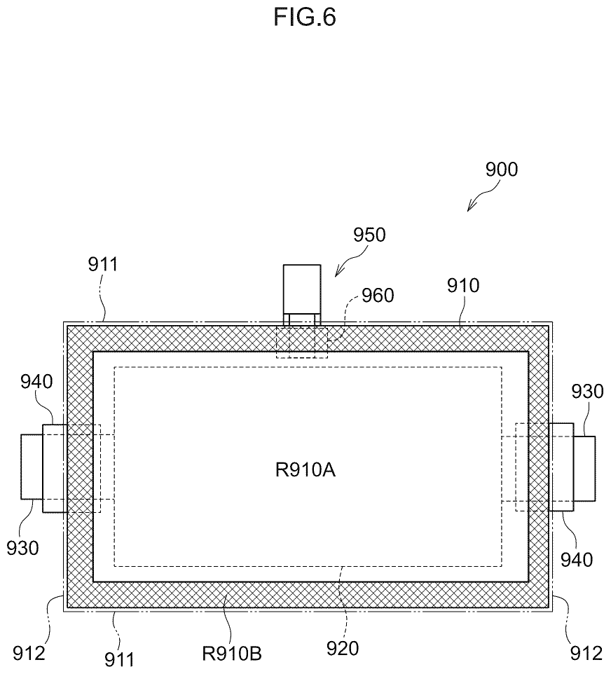

### DETAILED DESCRIPTION

Hereinafter, embodiments of the present disclosure will be described. These descriptions and examples illustrate embodiments and do not limit the scope of the embodiments.

In the present disclosure, a combination of two or more preferred embodiments is a more preferred embodiment.

In the present disclosure, a numerical range expressed using “to” means a range in which the numerical values described before and after “to” are included as the lower limit value and the upper limit value.

In numerical ranges given in a stepwise manner in the present disclosure, the upper limit or lower limit given in one numerical range may be replaced with the upper limit or lower limit of another numerical range described in a stepwise manner. In the numerical ranges set forth in the present disclosure, the upper or lower limit of a numerical range may be replaced with a value set forth in the examples.

Hereinafter, embodiments of a battery of the present disclosure will be described with reference to the drawings. In the drawings, the same or corresponding parts are denoted by the same reference numerals, and description thereof will not be repeated.

### (1) First Embodiment

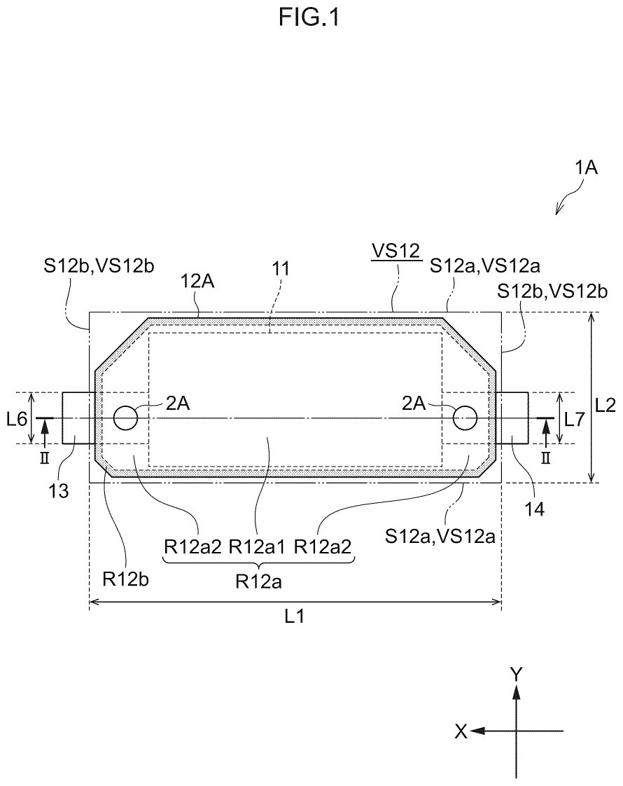

As shown in FIG. 1, a battery 1A according to the first embodiment includes an electrode body 11, a laminate exterior body 12A, a positive electrode tab 13, a negative electrode tab 14, and a nonaqueous electrolyte (not shown). The battery 1A has a rectangular parallelepiped shape.

In the present embodiment, the longitudinal direction of the main surface of the battery 1A is defined as the X-axis direction, the transverse direction of the main surface of the battery 1A is defined as the Y-axis direction, and the thickness direction of the battery 1A is defined as the Z-axis direction. Each of the X-axis, the Y-axis, and the Z-axis is orthogonal to each other. The X-axis is an example of a first direction. The Y-axis is an example of a second direction. The Z-axis is an example of a third direction. Note that these orientations do not limit the orientation of the battery of the present disclosure during use.

The laminate exterior body 12A houses therein an electrode body 11 and a nonaqueous electrolyte. The positive electrode tab 13 protrudes from the laminate exterior body 12A toward the X-axis positive direction. The negative electrode tab 14 protrudes from the laminate exterior body 12A toward the X-axis negative direction.

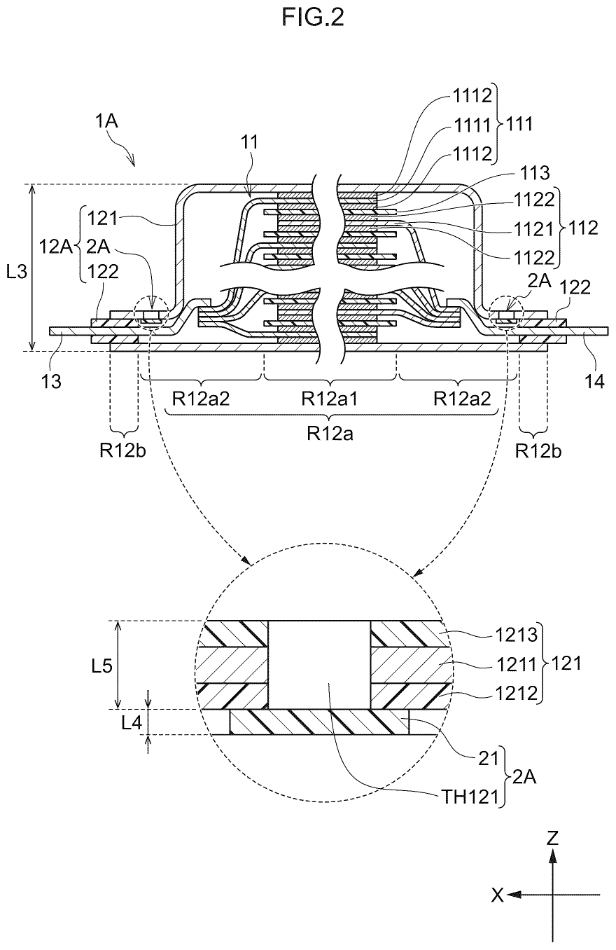

The length L1 of the battery 1A in the X-axis direction (see FIG. 1) is, for example, 530 mm to 600 mm. The length L2 of the battery 1A in the Y-axis direction (see FIG. 1) is, for example, 80 mm to 110 mm. The length L3 of the battery 1A in the Z-axis direction (see FIG. 2) is, for example, 7.0 mm to 9.0 mm.

### (1.1) Electrode Body

The structure of the electrode body 11 is layer-type. As shown in FIG. 2, the electrode body 11 includes plural positive electrode sheets 111, plural negative electrode sheets 112, and plural separator sheets 113. In the electrode body 11, a positive electrode sheet 111 and a negative electrode sheet 112 are alternately layered along the Z-axis direction via a separator sheet 113.

The number of each of the positive electrode sheet 111, the negative electrode sheet 112, and the separator sheet 113 is not particularly limited, and is appropriately selected in accordance with the use of the battery 1A.

### (1.1.1) Positive Electrode Sheet

The positive electrode sheet 111 has a positive electrode current collector 1111 (for example, aluminum foil) and a positive electrode active material layer 1112 supported on both surfaces of the positive electrode current collector 1111. The positive electrode active material layer 1112 contains a positive electrode active material. The positive electrode active material releases lithium ions into or occludes lithium ions from the nonaqueous electrolyte. The positive electrode active material may be a known positive electrode active material (for example, LiNiO₂ or LiNi_{1/3}Co_{1/3}Mn_{1/3}O₂). The positive electrode active material layer 1112 may further contain a known conductive material (for example, carbon black), trilithium phosphate, and a known binder (for example, polyvinylidene fluoride).

### (1.1.2) Negative Electrode Sheet

The negative electrode sheet 112 has a negative electrode current collector 1121 (for example, copper foil) and a negative electrode active material layer 1122 supported on both surfaces of the negative electrode current collector 1121. The negative electrode active material layer 1122 contains a negative electrode active material. As the negative electrode active material charges and discharges, lithium ions, which are charge carriers, are occluded from the nonaqueous electrolyte and released into the nonaqueous electrolyte. The negative electrode active material may be any known negative electrode active material (artificial graphite or lithium-alloy (for example, LiXM, where M is C, Si, Sn, Sb, Al, Mg, Ti, Bi, Ge, Pb or P, and X is a natural number)). The negative electrode active material layer 1122 may further contain a known binder (for example, a styrene-butadiene copolymer).

### (1.1.3) Separator Sheet

The separator sheet 113 electrically insulates the positive electrode sheet 111 and the negative electrode sheet 112, and provides a lithium ion transfer path between the positive electrode active material layer 1112 and the negative electrode active material layer 1122. Examples of the separator sheet 113 include a porous film. Examples of the material of the porous film include polyethylene and polypropylene. The separator sheet 113 may have a single-layer structure or a multilayer structure.

### (1.2) Laminate Exterior Body

The laminate exterior body 12A covers the electrode body 11 and seals the electrode body 11 and the nonaqueous electrolyte together with the positive electrode tab 13 and the negative electrode tab 14. The laminate exterior body 12A has a single-cup structure (see FIG. 2). A “laminate exterior body having a single-cup structure” refers to a single laminate exterior body having a bending line, one cup part (recessed part) which can accommodate the entire electrode body, and a flat part, in which, as a result of bending along the bending line, the flat part covers the recessed part.

As shown in FIG. 2, the laminate exterior body 12A has two mechanisms 2A, a laminate sheet 121, and plural tab films 122. Each of the plural tab films 122 is welded to the positive electrode tab 13 or the negative electrode tab 14, and to the laminate sheet 121. Details of the mechanism 2A will be described later with reference to FIG. 2.

As shown in FIG. 1, the laminate exterior body 12A has a non-welded region R12a and a welded region R12b. In the non-welded region R12a, the laminate sheets 121 are not welded to each other. In the welded region R12b, the laminate sheets 121 are welded to each other. The welded region R12b seals the non-welded region R12a. The non-welded region R12a has a housing region R12al and an intermediate region R12a2. The housing region R12a1 houses the electrode body 11. The intermediate region R12a2 is positioned between the housing region R12al and the welded region R12b.

The intermediate region R12a2 includes two through-holes TH121 which penetrate the laminate sheet 121, and a lid part 21 which occludes the through-hole TH121. The lid part 21 is welded to the laminate sheet 121. In the first embodiment, the thickness L4 of the lid part 21 (the length L4 in the Z-axis direction) (see FIG. 2) is thinner than the thickness L5 of the laminate sheet 121 (i.e., the length L5 in the Z-axis direction) (see FIG. 2).

### (1.2.1) Mechanism

In the first embodiment, the mechanism 2A includes the lid part 21 which occludes the through-hole TH121. When the pressure inside the laminate exterior body 12A exceeds a threshold value, the mechanism 2A switches from a closed state to an open state. The “closed state” refers to a state in which the lid part 21 is not torn. In other words, the lid part 21 occludes the through-hole TH121. As a result, the interior of the laminate exterior body 12A (i.e., the non-welded region R12a) is closed. The “open state” refers to a state in which the lid part 21 is torn. In other words, the lid part 21 does not occlude the through-hole TH121. As a result, the interior of the laminate exterior body 12A is opened to the outside of the laminate exterior body 12A.

The laminate exterior body 12A has a rectangular parallelepiped shape. As shown in FIG. 1, the laminate exterior body 12A has a pair of first sides S12a extending in the X-axis direction and a pair of second sides S12b extending in the Y-axis direction. The mechanism 2A is positioned in a virtual region VS12 in plan view. The virtual region VS12 is a region enclosed by a pair of first virtual straight lines VS12a and a pair of second virtual straight lines VS12b. The pair of first virtual straight lines VS12a includes the pair of first sides S12a. The pair of second virtual straight lines straight b includes the pair of second sides S12b. In the Z-axis direction, the length of the mechanism 2A (i.e., the sum of the length L4 and the length L5) is shorter than the length of the laminate exterior body 12A (i.e., the length L3 of the battery 1A in the Z-axis direction).

The lid part 21 contains a thermoplastic resin. Examples of the thermoplastic resin include olefinic resins (for example, polypropylene, polyethylene, and the like), polyvinyl chloride, and polyvinylidene chloride. The lid part 21 may be a resin sheet or may have the same layer structure as the laminate sheet 121.

### (1.2.2) Laminate Sheet

The laminate exterior body 12A is configured by a laminate sheet 121. The laminate sheet 121 has a metal layer 1211, an inner resin layer 1212, and an outer resin layer 1213. The inner resin layer 1212 is layered on the surface of the metal layer 1211 on the side of the electrode body 11. The outer resin layer 1213 is layered on the surface of the metal layer 1211 at the opposite side from the electrode body 11. The metal layer 1211 blocks gas (for example, moisture or air) outside of the battery 1A and inside of the battery 1A from entering and leaving. The material of the metal layer 1211 is a metal (for example, aluminum). The inner resin layer 1212 electrically insulates the electrode body 11, the positive electrode tab 13, and the negative electrode tab 14 from the metal layer 1211. The inner resin layer 1212 may contain a thermoplastic resin. The outer resin layer 1213 improves the durability of the laminate sheet 121. The outer resin layer 1213 may contain a thermoplastic resin. Examples of the thermoplastic resin of each of the inner resin layer 1212 and the outer resin layer 1213 include the same resins as those exemplified as the thermoplastic resin of the lid part 21.

### (1.2.3) Tab Film

The tab film 122 has a function of electrically insulating the laminate sheet 121 from the positive electrode tab 13 and the negative electrode tab 14, and a function of connecting the laminate sheet 121 to the positive electrode tab 13 and the negative electrode tab 14. The tab film 122 contains a thermoplastic resin. Examples of the thermoplastic resin of the tab film 122 include the same resins as those exemplified as the thermoplastic resin of the lid part 21.

### (1.3) Positive Electrode Tab

The positive electrode tab 13 is electrically connected to the plural positive electrode current collectors 1111. Examples of the material of the positive electrode tab 13 include a metal (for example, stainless steel (SUS)). The length L6 of the positive electrode tab 13 in the Y-axis direction (see FIG. 1) is, for example, 40 mm to 50 mm.

### (1.4) Negative Electrode Tab

The negative electrode tab 14 is electrically connected to the plural negative electrode current collectors 1121. Examples of the material of the negative electrode tab 14 include a metal (for example, stainless steel (SUS)). The length L7 of the negative electrode tab 14 in the Y-axis direction (see FIG. 1) is, for example, 40 mm to 50 mm.

### (1.5) Nonaqueous Electrolyte

The battery 1A includes a nonaqueous electrolyte. The nonaqueous electrolyte is housed in the laminate exterior body 12A together with the electrode body 11. It is sufficient that the nonaqueous electrolyte be a solution in which a support salt as an electrolyte (for example, LiPF₆) is dissolved or dispersed in a nonaqueous solvent (for example, ethyl carbonate). The nonaqueous electrolyte may contain various additives such as lithium bis (oxalato) borate.

### (1.6) Action and Effects

As described with reference to FIGS. 1 and 2, the battery 1A includes the electrode body 11 and the laminate exterior body 12A. The laminate exterior body 12A has the mechanism 2A. The mechanism 2A is positioned in the virtual region VS12. In the Z-axis direction, the length of the mechanism 2A (i.e., the sum of the length L4 and the length L5) is shorter than the length of the laminate exterior body 12A (i.e., the length L3 of the battery 1A in the Z-axis direction).

As a result, the battery 1A can release gas inside the battery 1A to the outside when the internal pressure of the battery 1A excessively increases. As a result, the occurrence of rupturing of the laminate exterior body 12A of the battery 1A is suppressed. The safety of the battery 1A is excellent. When the battery 1A is housed in the case, forming a module, it is not necessary to secure the conventional valve device housing space inside the case. As a result, the battery 1A can improve the volumetric efficiency of the module.

As described with reference to FIGS. 1 and 2, in the battery 1A, the thickness L4 of the lid part 21 (see FIG. 2) is thinner than the thickness L5 of the laminate sheet 121 (see FIG. 2). The mechanism 2A includes a lid part 21 which occludes the through-hole TH121. The closed state of the mechanism 2A refers to a state in which the lid part 21 is not torn. The open state of the mechanism 2A refers to a state in which the lid part 21 is torn.

Therefore, the strength of the lid part 21 is relatively low. As a result, when the internal pressure of the battery 1A excessively increases, the lid part 21 is susceptible to tearing due to the internal pressure of the battery 1A. As a result, the battery 1B can release gas inside the battery 1B to the exterior when the internal pressure of the battery 1B excessively increases, by means of a simple configuration.

### (2) Second Embodiment

The battery 1B of the second embodiment of the present disclosure is the same as the battery 1A of the first embodiment except that, mainly, the structure of the mechanism is different.

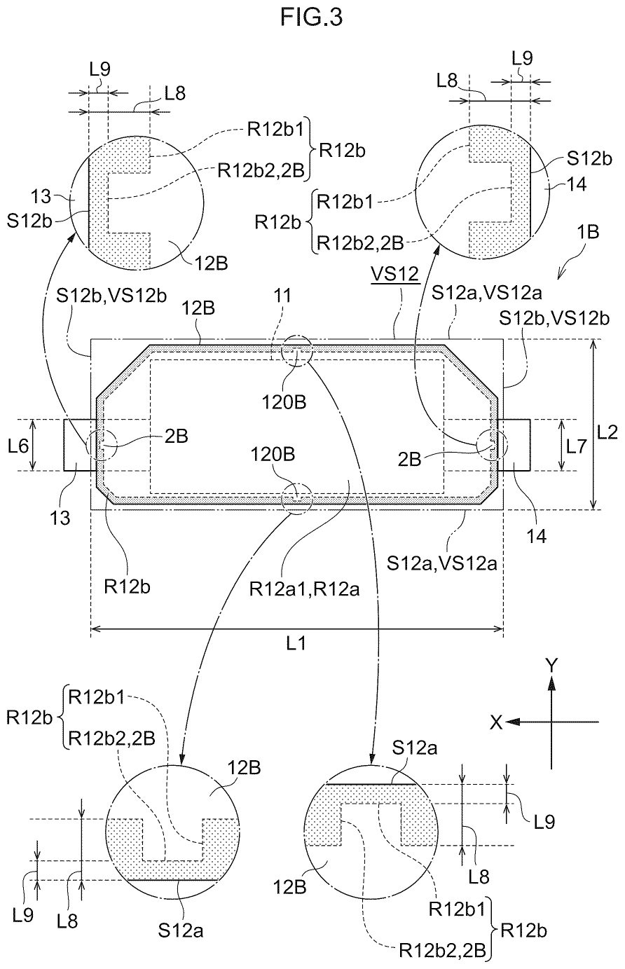

As shown in FIG. 3, the battery 1B includes an electrode body 11, a laminate exterior body 12B, a positive electrode tab 13, a negative electrode tab 14, and a nonaqueous electrolyte (not shown).

The laminate exterior body 12B is the same as the laminate exterior body 12A except that the mechanism 2B is provided instead of the mechanism 2A.

The laminate exterior body 12B has four mechanisms 2B, a laminate sheet 121, and plural tab films 122.

The laminate exterior body 12B has a non-welded region R12a and a welded region R12b. In the second embodiment, the welded region R12b has a main part R12b1 and four narrow parts R12b2. The main part R12b1 is a part having a welding width of a specific width L8 (see FIG. 3). The narrow part R12b2 has a welding width of a width L9 (see FIG. 3) which is shorter than the specific width L8. A part of the welded region R12b that is not the four narrow parts R12b2 is configured by the main part R12b1.

### (2.1) Mechanism

In the second embodiment, the mechanism 2B includes a narrow part R12b2. When the pressure inside the laminate exterior body 12B exceeds the threshold value, the mechanism 2B switches from a closed state to an open state. The “closed state” refers to a state in which the laminate sheets 121 are welded to each other at the narrow part R12b2. In other words, the interior of the laminate exterior body 12B (i.e., the non-welded region R12a) is closed. The “open state” refers to a state in which the laminate sheets 121 are separated from each other at the narrow part R12b2. In other words, the inside of the laminate exterior body 12B is opened to the outside of the laminate exterior body 12B.

The laminate exterior body 12B has a rectangular parallelepiped shape. The laminate exterior body 12B has a pair of first sides S12a extending in the X-axis direction and a pair of second sides S12b extending in the Y-axis direction. As shown in FIG. 3, the mechanism 2B is positioned inside the virtual region VS12 in plan view. The virtual region VS12 is a region enclosed by a pair of first virtual straight lines VS12a and a pair of second virtual straight lines VS12b. The pair of first virtual straight lines VS12a includes the pair of first sides S12a. The pair of second virtual straight lines VS12b includes the pair of second sides S12b. In the Z-axis direction, the length of the mechanism 2B is shorter than the length of the laminate exterior body 12B (i.e., the length L3 of the battery 1B in the Z-axis direction).

### (2.2) Action and Effects

As described with reference to FIG. 3, the battery 1B includes the electrode body 11 and the laminate exterior body 12B. The laminate exterior body 12B has a mechanism 2B. The mechanism 2B is positioned inside the virtual region VS12. In the Z-axis direction, the length of the mechanism 2B is shorter than the length of the laminate exterior body 12B (i.e., the length L3 of the battery 1B in the Z-axis direction).

As a result, the battery 1B can release the gas inside the battery 1B to the outside when the internal pressure of the battery 1B excessively increases. As a result, the occurrence of rupturing of the laminate exterior body 12B of the battery 1B is suppressed. The safety of the battery 1B is excellent. When the battery 1B is housed in the case, forming a module, it is not necessary to secure the conventional valve device housing space in the case. As a result, the battery 1B can improve the volume efficiency of the module.

As described with reference to FIG. 3, in the battery 1B, the welded region R12b has the main part R12b1 and four narrow parts R12b2. The mechanism 2B includes the narrow part R12b2. The closed state refers to a state in which the laminate sheets 121 are welded to each other at the narrow part R12b2. The open state refers to a state in which the laminate sheets 121 are separated from each other at the narrow part R12b2.

As a result, the welded laminate sheets 121 at the narrow part R12b2 are more likely to be separated from each other than the welded laminate sheets 121 at the main part R12b1. Therefore, when the internal pressure of the battery 1B excessively increases, it is easier for the welded laminate sheets 121 at the narrow part R12b2 to be separated from each other by the internal pressure of the battery 1B. As a result, the battery 1B can release gas inside the battery 1B to the exterior when the internal pressure of the battery 1B excessively increases, by means of a simple configuration.

### (3) Third Embodiment

The battery 1C of the third embodiment of the present disclosure is the same as the battery 1A of the first embodiment except that, mainly, the structure of the mechanism is different.

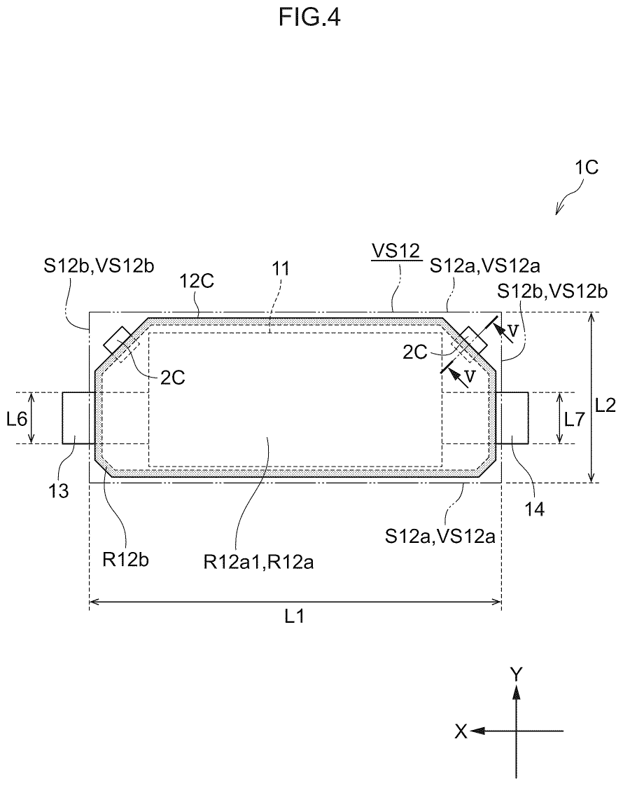

As shown in FIG. 4, the battery 1C includes an electrode body 11, a laminate exterior body 12C, a positive electrode tab 13, a negative electrode tab 14, and a nonaqueous electrolyte (not shown).

The laminate exterior body 12C is the same as the laminate exterior body 12A except that a mechanism 2C is provided instead of the mechanism 2A.

The laminate exterior body 12C has two mechanisms 2C, a laminate sheet 121, and plural tab films 122.

### (3.1) Mechanism

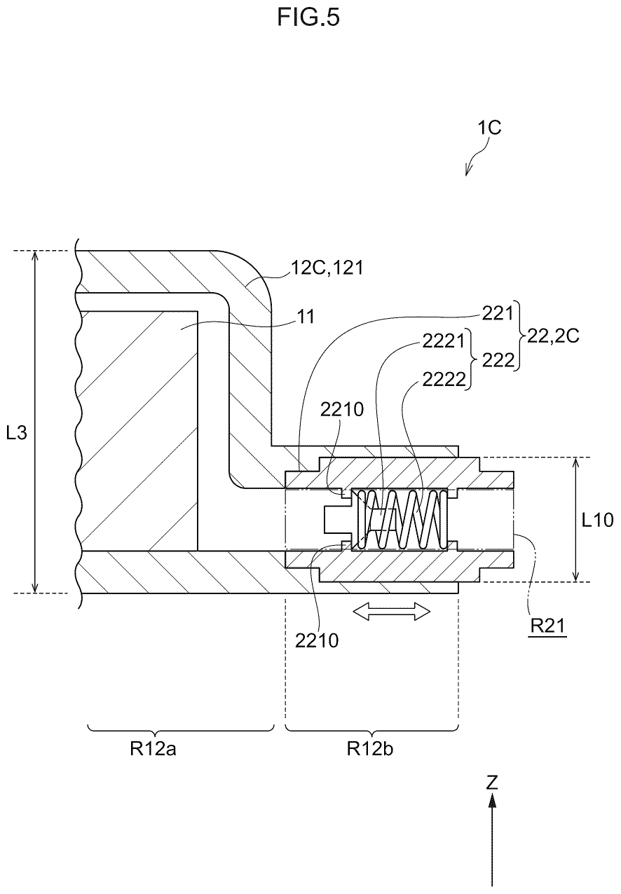

In the third embodiment, the mechanism 2C includes two check valves 22. The check valve 22 is a known disc-type check valve. The check valve 22, as shown in FIG. 5, includes a body part 221 and an on-off valve 222. The on-off valve 222 is arranged inside the body part 221. The body part 221 is a cylindrical body. The body part 221 forms a gas flow path R21. The gas flow path R21 communicates the non-welded region R12a with the outside of the laminate exterior body 12C. The on-off valve 222 opens and closes the gas flow path R21. The on-off valve 222 has a lid part 2221 and a spring 2222.

When the pressure inside the laminate exterior body 12C exceeds a threshold value, the mechanism 2C switches from a closed state to an open state. The “closed state” refers to a state in which the on-off valve 222 closes the gas flow path R21. The body part 221 has an inner partition wall 2210. Specifically, the closed state is a state in which the lid part 2221 of the on-off valve 222 and the inner partition wall 2210 of the body part 221 contact each other. The “open state” refers to a state in which the on-off valve 222 opens the gas flow path R21. Specifically, the open state is a state in which the lid part 2221 of the on-off valve 222 and the inner partition wall 2210 of the body part 221 do not contact each other.

The laminate exterior body 12C has a rectangular parallelepiped shape. The laminate exterior body 12C has a pair of first sides S12a extending in the X-axis direction and a pair of second sides S12b extending in the Y-axis direction. The welded region R12b includes a region in which the body part 221 is interposed between the laminate sheets 121. As shown in FIG. 4, the mechanism 2C is positioned inside the virtual region VS12 in plan view. The virtual region VS12 is a region enclosed by a pair of first virtual straight lines VS12a and a pair of second virtual straight lines VS12b. The pair of first virtual straight lines VS12a includes the pair of first sides S12a. The pair of second virtual straight lines VS12b includes the pair of second sides S12b. As shown in FIG. 5, in the Z-axis direction, the length L10 of the mechanism 2C (see FIG. 5) is shorter than the length L3 of the laminate exterior body 12C (see FIG. 5).

### (3.2) Action and Effects

As described with reference to FIGS. 4 and 5, the battery 1C includes the electrode body 11 and the laminate exterior body 12C. The laminate exterior body 12C has a mechanism 2C. The mechanism 2C is positioned inside the virtual region VS12. In the Z-axis direction, the length L10 of the mechanism 2C (see FIG. 5) is shorter than the length L3 of the laminate exterior body 12C (see FIG. 5).

As a result, the battery 1C can release the gas inside the battery 1C to the outside when the internal pressure of the battery 1C excessively increases. As a result, the occurrence of rupturing of the laminate exterior body 12C of the battery 1C is suppressed. The safety of the battery 1C is excellent. When the battery 1C is housed in the case, forming a module, it is not necessary to secure the conventional valve device housing space in the case. As a result, the battery 1C can improve the volumetric efficiency of the module.

As described with reference to FIGS. 4 and 5, the mechanism 2C includes two check valves 22. The check valve 22 includes a body part 221 and an on-off valve 222. The welded region R12b includes a region in which the body part 221 is interposed between the laminate sheets 121. The closed state refers to a state in which the on-off valve 222 closes the gas flow path R21. The open state refers to a state in which the on-off valve 222 opens the gas flow path R21.

The check valve 22 can return from the open state to the closed state. As a result, the battery 1C can be reused even if the number of times that the internal pressure of the battery 1C has excessively increased is two or more.

### (4) Variant Example

In the battery 1A, the laminate exterior body 12A has two mechanisms 2A (i.e., the lid part 21 which closes the through-hole TH121), but the present disclosure is not limited thereto. The laminate exterior body 12A may have one mechanism 2A, or may have three or more mechanisms 2A. The laminate exterior body 12A may have, in addition to the mechanism 2A, at least one of one or more mechanisms 2B or one or more mechanisms 2C.

In the battery 1B, the laminate exterior body 12B has four mechanisms 2B (i.e., the narrow part R12b2), but the present disclosure is not limited thereto. The laminate exterior body 12B may have one to three mechanisms 2B, or may have five or more mechanisms 2B. The laminate exterior body 12B may have, in addition to the mechanism 2B, at least one of one or more mechanisms 2A or one or more mechanisms 2C.

In the battery 1C, the laminate exterior body 12C has two mechanisms 2C (i.e., the check valve), but the present disclosure is not limited thereto. The laminate exterior body 12B may have one mechanism 2C, or may have three or more mechanisms 2C. The laminate exterior body 12C may have, in addition to the mechanism 2C, at least one of one or more mechanisms 2A or one or more mechanisms 2B.

In the batteries 1A to 1C, the structure of the electrode body 11 is layer-type, but the present disclosure is not limited thereto. The structure of the electrode body of the present disclosure may be winding-type.

While the laminate exterior bodies 12A to 12C have a single-cup structure (see FIG. 2), the present disclosure is not limited thereto. In the present disclosure, the laminate exterior bodies 12A to 12C may have a double-cup structure. A “double-cup structure” refers to a single laminate exterior body having a bending line, one first cup part (recessed part) capable of housing a part of the electrode body, and one second cup part (recessed part) capable of housing a part of the electrode body, which can accommodate the entire electrode body in a space formed by overlapping the first cup part and the second cup with each other by bending along the bending line.

In the batteries 1A to 1C, the positive electrode tab 13 protrudes from the laminate exterior bodies 12A to 12C in the Y-axis positive direction, and the negative electrode tab 14 protrudes from the laminate exterior bodies 12A to 12C in the Y-axis negative direction; however, the present disclosure is not limited thereto. In the present disclosure, the positive electrode tab 13 and the negative electrode tab 14 may protrude from the laminate exterior bodies 12A to 12C in the Y-axis positive direction or the Y-axis negative direction.

What is claimed is:

1. A battery, comprising:
an electrode body; and
a laminate exterior body accommodating the electrode body at an interior thereof, wherein:
the laminate exterior body has a mechanism switchable between a closed state of closing the interior and an open state of opening the interior to an exterior of the laminate exterior body,
the mechanism switches from the closed state to the open state when a pressure of the interior of the laminate exterior body exceeds a threshold value,
the laminate exterior body has a rectangular parallelepiped shape,
the laminate exterior body has, in plan view, a pair of first sides extending in a first direction and a pair of second sides extending in a second direction orthogonally intersecting the first direction,
the mechanism is positioned within a virtual region enclosed by a pair of first virtual straight lines including the pair of first sides and by a pair of second virtual straight lines including the pair of second sides, and
a length of the mechanism is shorter than a length of the laminate exterior body in a third direction orthogonally intersecting each of the first direction and the second direction.

2. The battery of claim 1, wherein:
the laminate exterior body is configured by laminate sheets,
the laminate exterior body has:
a non-welded region at which the laminate sheets are not welded together; and
a welded region sealing the non-welded region and at which the laminate sheets are welded together,
the non-welded region includes:
a housing region housing the electrode body; and
an intermediate region positioned between the housing region and the welded region,
the intermediate region includes:
at least one through-hole penetrating the laminate sheets; and
a lid part welded to the laminate sheets and occluding the through-holes,
a thickness of the lid part is less than a thickness of the laminate sheets,
the mechanism includes the lid part occluding the through-holes,
the closed state refers to a state in which the lid part is not torn, and
the open state refers to a state in which the lid part is torn.

3. The battery of claim 1, wherein:
the laminate exterior body is configured by laminate sheets,
the laminate exterior body has:
a non-welded region at which the laminate sheets are not welded together; and
a welded region sealing the non-welded region and at which the laminate sheets are welded together,
the non-welded region includes a housing region housing the electrode body,
the welded region has:
a main part having a specific welding width; and
at least one narrow part having a smaller welding width than the specific welding width,
the closed state refers to a state in which the laminate sheets are welded together at the narrow part, and
the open state refers to a state in which the laminate sheets are separated from each other at the narrow part.

4. The battery of claim 1, wherein:
the laminate exterior body is configured by laminate sheets,
the laminate exterior body has:
a non-welded region at which the laminate sheets are not welded together; and
a welded region sealing the non-welded region and at which the laminate sheets are welded together,
the non-welded region includes a housing region housing the electrode body,
the mechanism includes at least one check valve,
the check valve includes:
a body part forming a gas flow path communicating the non-welded part with the exterior of the laminate exterior body; and
an on-off valve configured to open and close the gas flow path,
the welded region includes a region at which the body part is interposed between the laminate sheets,
the closed state refers to a state in which the gas flow path is closed by the on-off valve, and
the open state refers to a state in which the gas flow path is opened by the on-off valve.
